(19) United States
(12) Patent Application Publication
(10) Pub. No.: US 2005/0071634 A1
(43) Pub. Date: Mar. 31, 2005

(54) Certification apparatus, method and device for authenticating message origin

(76) Inventors: Claude Meggle, Paris (FR); Bruno Choiset, Villiers Saint Frederic (FR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/496,203

(22) PCT Filed: Nov. 19, 2002
(86) PCT No.: PCT/FR02/03948

(30) Foreign Application Priority Data
Nov. 19, 2001 (FR) 01/14929

(51) Int. Cl. H04L 9/00

(52) U.S. Cl. 713/168

(57) ABSTRACT

The invention concerns an apparatus comprising a device designed to encode an original message by means of a digital key whereof the apparatus manufacturer is the owner. The electronic equipment, to authenticate that a received message is a message coming from the apparatus authorized to certify said message, comprises a device designed to decode said received message with the digital key whereof the manufacturer of the apparatus is the owner. The method comprises: a first step whereby an encoded message is generated by means of the apparatus which encodes an original message by means of a digital key whereof the manufacturer of the apparatus is the owner; a second step whereby the encoded message is transmitted to the addressee electronic equipment; a third step whereby the encoded message is decoded with said digital key.

The field of the invention is that of secure remote transactions performed in particular on open networks. The invention is particularly useful for electronic commerce, for example on the Internet.

An open network has the characteristic of being intrusive, that is to say that a third party can interpose himself or herself between the sender and the addressee of the transaction so as to falsify the integrity thereof.

To authenticate an origin of a message related to a transaction and transmit it over the open network and to guarantee the content thereof, use is generally made of cryptographic protocols, of which the known literature is rich.

When a transaction is made by means of a microprocessor card with a remote server, microprocessor cards exist today capable of participating directly in cryptographic protocol implementation.

An individual who is a legitimate holder of the microprocessor card then validates the transaction by means of a secret password, for example a sequence of four digits, which he alone is assumed to know.

To perform his transaction, the individual inserts his microprocessor card into an apparatus capable of setting up a dialogue with this card. The apparatus is commonly equipped with an interface to allow the individual to communicate his password to the microprocessor card.

It is known that the apparatus must be trustworthy in order to avoid false transactions, for example by copying and/or transmission of the password. To ensure the trustworthiness of the apparatus, a certifying body approves one or more manufacturers, imposing thereon certain standards to be complied with.

To avoid malicious intrusions into the apparatus, one solution consists in endowing the apparatus with means for implementing an additional cryptographic protocol for example with a private/public key pair, the private key being kept secret in the apparatus.

Such a carefully elaborated solution is certainly very good as regards to security but it may have a drawback in terms of costs since the cryptographic protocols often require numerous resources and a certain degree of sophistication of the apparatus.

To promote the development of electronic transactions, it is interesting to be able to employ simplified apparatus, their lower cost encouraging their purchase. The expanding capabilities of microprocessor cards are leading to the design of simplified apparatus. However, the simpler an apparatus is, the easier it is to copy. This raises the problem of avoiding a proliferation of apparatus of doubtful quality that might not meet a minimum of security.

A first subject of the invention is a method for authenticating that a message received by an addressee electronic equipment is a message coming from an apparatus authorized to certify said message.

The method is noteworthy in that it comprises:
a first step in which a coded message is generated by means of the apparatus which codes an original message by means of a digital key whereof a manufacturer of the apparatus is the owner;
a second step in which the coded message is transmitted to the addressee electronic equipment;
a third step in which the coded message is decoded by means of said digital key.

More particularly, the digital key whereof the manufacturer is the owner, reproduces a registered trademark whereof the owner manufacturer is the proprietor.

Advantageously, the original message is coded by combining each bit of the digital key with a bit of corresponding rank of the original message, by means of a logical combination of “exclusive or” type. The coded message is then decoded by combining each bit of the digital key with a bit of the same corresponding rank of the coded message, by means of a logical combination of “exclusive or” type.

The method is further improved when the coded message is transmitted with a manufacturer identification number.

A second subject of the invention is an apparatus for certifying a message intended to be transmitted to an addressee electronic equipment.

The apparatus is noteworthy in that it comprises a first device designed to code an original message by means of a digital key whereof a manufacturer of the apparatus is the owner.

More particularly, the apparatus comprises a first register for containing each bit of said digital key, a second register for containing bits of the original message, each rank corresponding to the rank of a bit of the first register, a third register for containing a logical combination of “exclusive or” type of each bit of the first register with a bit of corresponding rank of the second register.

Advantageously, the apparatus comprises a second device designed to add to the coded message an owner manufacturer identification number of said digital key.

A third subject of the invention is an electronic equipment for authenticating that a message received is a message coming from an apparatus authorized to certify said message.

The electronic equipment is noteworthy in that it comprises a first device designed to decode said message received by means of a digital key whereof a manufacturer of the apparatus is the owner.

More particularly, the first device comprises a first register for containing each bit of said digital key, a second register for containing bits of the coded message, each rank corresponding to the rank of a bit of the first register, a third register for containing a logical combination of “exclusive or” type of each bit of the first register with a bit of corresponding rank of the second register.

Advantageously, the electronic equipment comprises a second device designed to determine said digital key as a function of a manufacturer identification number received with the coded message.

The invention will be better understood on reading the description which follows of embodiment example with reference to the appended drawings in which:

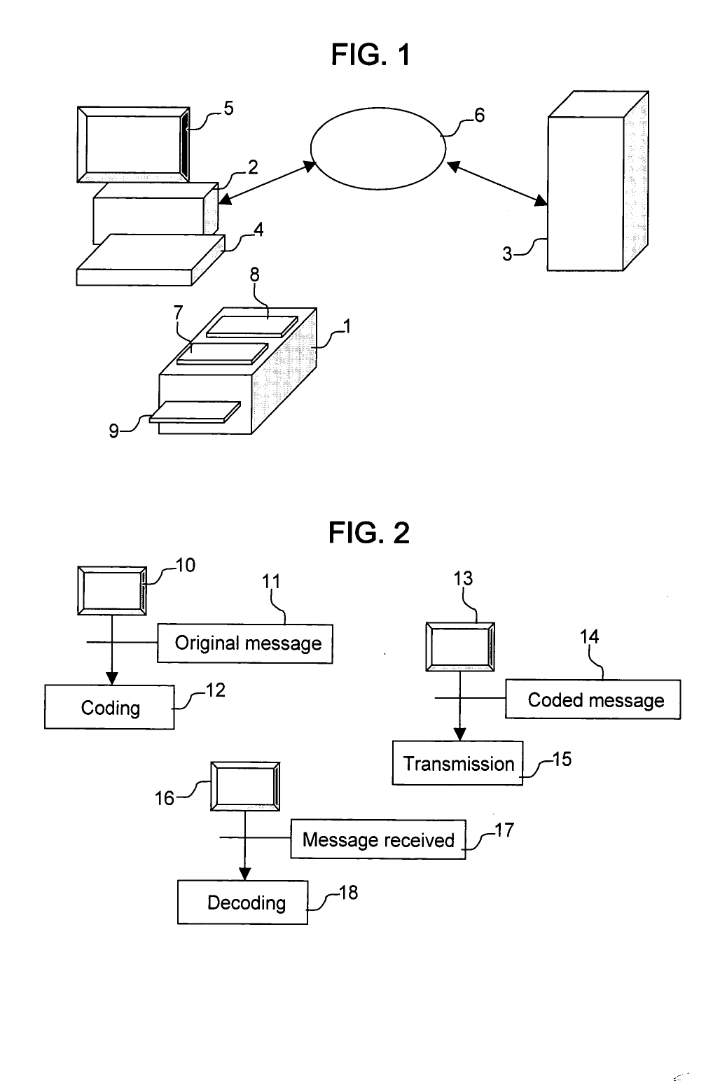

FIG. 1 shows an environment for implementing the invention;

FIG. 2 is a chart of steps of the method in accordance with the invention;

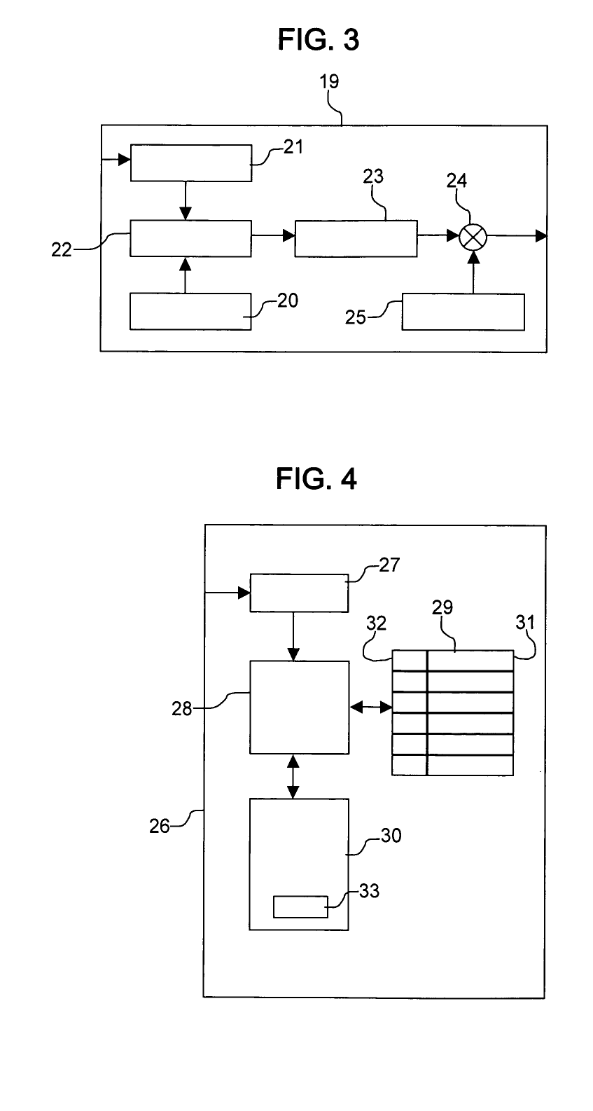

FIG. 3 is a device diagram of the apparatus according to the invention;

FIG. 4 is a device diagram of the equipment according to the invention.

FIG. 1 makes it possible to show the usefulness of a certification apparatus 1 and of an authentication method. A computer 2 can connect to a remote server 3 via a network 6 of open type such as the internet network. The computer 2 allows an individual to initiate a transaction such as for example explained presently.

The computer 2 has a keyboard 4 that allows the individual to input information into the computer 2. The computer 2 also has a screen 5 for displaying information originating from the server 3 or that results from information input via the keyboard 4.

When the individual has initiated a transaction from the computer 2, for example to pay for the purchase of an article presented on the screen 5, the server 3 dispatches a challenge message to the computer 2 via the network 6 to authenticate the transaction.

A microprocessor card 9 is provided for generating a so-called original message in response to the challenge message. The card 9 is for example a credit card allowing a bank account of the individual to be debited. The challenge message is communicated to the card 9 by the apparatus 1 in which the card 9 is inserted. The card 9 then communicates the original message to the apparatus 1.

Applications exist in which the apparatus 1 is connected physically to the computer 2 by cable or by radio or infrared emission. The challenge message is then transmitted to the apparatus 1 through this physical connection. The apparatus 1 codes the original message received from the card 9 to certify that it was generated by the card 9 at the desire of the individual, the legitimate holder of the card 9. To mark his desire, the individual types for example a secret code known to him alone into a keyboard 7 of the apparatus 1 which has it validated by the card 9. The apparatus 1 then transmits the message thus coded to the computer 2 through this same physical connection.

In FIG. 1, the apparatus 1 is not connected physically to the computer 2. The challenge message is displayed on the screen 5 by the computer 2. The individual reads the challenge message on the screen 5 and types it into the keyboard 7 of the apparatus 1. The apparatus 1 comprises a screen 8 for displaying the coded message which results from the original message. The individual types the coded message into the keyboard 4 of the computer 2. The absence of any outside physical connection of the apparatus 1 offers greater flexibility of use since it is unnecessary to set up any physical connection between the apparatus 1 and the computer 2 with the compatibility problems that this might cause. The absence of any outside physical connection of the apparatus 1 also offers good protection against intrusions by electronic messages into the casing 1 unbeknown to the user individual.

FIG. 2 shows essential steps of the method for authenticating that a message received by an addressee electronic equipment such as the server 3 for example in the environment previously explained with reference to FIG. 1, is a message coming from an apparatus authorized to certify this message.

After having transmitted the challenge message to the card 9, the apparatus 1 is in a standby step 10 awaiting a response from the card 9.

Reception of a so-called original message validates a transition 11 which activates a step 12 in the apparatus 1.

In step 12, the apparatus 1 codes the original message by means of a numerical whereof a manufacturer of the apparatus 1 is the owner. To carry out basic functions such as transmission of the challenge message to the card 9 and reception of the original message sent by the card 9 in response to the challenge message, several apparatus manufacturers are possible. Each manufacturer manufactures a type of apparatus possibly with the manufacturer's own specific features. It is considered that an apparatus is authorized to certify messages when the manufacturer thereof is approved, that is to say meets certain security standards complying with a specification duly accredited by a recognized certifying body. An identification number is generally allocated to each approved manufacturer.

In the apparatus 1 according to the invention, the coding of the original message by means of a key whereof the approved manufacturer of the apparatus is the owner, makes it possible to distinguish which manufacturer of the apparatus is the one approved originally. If another manufacturer manufactures an apparatus that uses this key without authorization from the approved manufacturer, this other manufacturer violates the ownership of the approved manufacturer. This other manufacturer is then punishable by penalties provided for in ownership protection laws. It is then unnecessary to implement complicated devices to keep the coding key secret. The resulting simplifications improve the coding in terms of cost and in terms of speed.

The coding key is in a particularly advantageous embodiment, a string of characters which reproduces a trademark registered by the approved manufacturer. The very widespread ASCII code makes it possible to represent the characters of the registered trademark in the form of an ordered set of bits, which is used to code the original message. If this set of bits is used in an apparatus manufactured by another manufacturer, the ASCII decoding of this series of bits makes it possible to reveal that this other manufacturer has reproduced and has made use of the trademark whereof the manufacturer who is the owner of the key is the proprietor. The infringement perpetrated on the owner manufacturer then constitutes forgery for which this other manufacturer is held responsible under civil liability.

This makes it possible to obtain a level of security that is satisfactory for numerous transactions in which a reduction in costs is a determining criterion. To avoid some other manufacturer, who is not authorized by the approved manufacturer who owns the key, producing an apparatus that uses this key without meeting the security standards, the owner of the trademark can take out a civil action for forgery. The owner can also oppose any new action to market an apparatus that he manufactured but whose state subsequently underwent a modification or an alteration liable to reduce the security level thereof.

The key put into digital form in the apparatus 1 need not be related to a cryptographic protocol. Advantageously, the original message is coded by combining each bit of the digital key with a bit of a corresponding rank of the original message, likewise in digital form, by means of a logical combination of “exclusive or” type. The original message is for example chopped up into one or if necessary more sequences of bits of length at most equal to the length of the digital key expressed as a number of bits so as to make each bit of the digital key correspond with a bit of the sequence. If the length of a sequence of bits is less than that of the key, it is possible to envisage a combination restricted to certain bits of the digital key or a sequence repetition so as to use all the bits of the digital key.

Following the transmission of the challenge message from the computer 2 to the apparatus 1, be it via a physical link or by display on the screen 5 and then typing onto the keyboard 7 by the user individual, the computer 2 is in a standby step 13.

Reception in the computer 2, of the coded message generated by means of the apparatus 1, validates a transition 14. Reception may be effected via a physical link between the computer 2 and the apparatus 1 or preferably from the keyboard 4 into which the user individual types the coded message that he reads on the screen 8 of the apparatus 1. The transition 14 then activates a step 15.

In step 15, the computer 2 transmits the coded message to the addressee electronic equipment 3 via the open network 6.

Following the transmission of the challenge message by the electronic equipment 3 to the computer 2 via the open network 6, the electronic equipment 3 is in a standby step 16.

Reception in the electronic equipment 3, of the coded message, validates a transition 17.

In step 18, the coded message is decoded by the electronic equipment 3 by means of the digital key which served to code the original message. The electronic equipment 3 hosts a server which has in memory the digital key whereof the approved manufacturer of the apparatus 1 is the owner. The hosted server next verifies that the decoded message corresponds to an original message which responds to the challenge message that it sent, so as to validate the transaction.

Advantageously, the coded message is decoded by combining each bit of the digital key with a bit of a corresponding rank of the coded message, by means of a logical combination of exclusive or type. This rank is the same as the one which served for the coding of the original message in the apparatus 1. This allows simple and fast processing, in particular when numerous transactions are in progress, related to a mass dissemination of apparatus of the type of the apparatus 1.

Of course, it is entirely in the interests of the approved manufacturer to authorize a server operator to make use of the digital key to decode messages. This promotes the use of apparatus manufactured by the approved manufacturer. A server operator who made use of the digital key whereof the approved manufacturer is the owner, without authorization, would violate this manufacturer's ownership and would thus expose himself to the penalties imposed by law. This makes it possible to recognize the authorized operator or operators of servers and contributes to the security of the transaction. This also protects each authorized server operator. If the latter detects fraudulent operation on another server, in particular if the digital key reproduces a trademark, the authorized operator is entitled to institute forgery proceedings in order to obtain compensation for the loss which is due to him.

It is noted that the coded message which passes from the computer 2 to the electronic equipment 3 carries the registered trademark in the form of a digital watermark.

The bitwise “exclusive or” decoding function is simple and fast. When there are several approved manufacturers of the apparatus 1 and consequently several possible digital keys for the same transaction, it is conceivable for the server to run through a list of digital keys, decoding the coded message with a key from the list until the decoded message corresponds to an original message which responds to the challenge message and to reject the transaction if no decoding gives any appropriate original message.

To speed up the decoding process, the apparatus 1 appends in clear the identifier of the approved manufacturer of the apparatus 1. The coded message transmitted with an identification number allows the server of the addressee electronic equipment that receives it to directly retrieve the digital key which corresponds to this identification number and to do just one decoding which succeeds or which fails.

The appending of the identification number to the coded message also affords an additional advantage in terms of protection. The association of the identification number with the digital key by an unauthorized manufacturer or server, constitutes an aggravating circumstance of violation of ownership since such an association is necessarily made wittingly. Such an unauthorized manufacturer or operator of a server could then be found criminally liable by a court and be punished with the penalties provided for by law.

FIG. 3 shows a diagram of a device 19 designed to code an original message by means of a digital key whereof a manufacturer of the apparatus is the owner. The device 19 which forms part of the apparatus 1 comprises a register 20 for containing each bit of the digital key and a register 21 for containing bits of the original message, each of rank corresponding to the rank of a bit of the register 20. According to a first embodiment, the register 20 is a permanent memory or receives from a permanent memory in the apparatus 1 an ASCII character string which reproduces the trademark registered by the approved manufacturer. According to a second embodiment, the register 20 is designed to receive from the keyboard 7 an ASCII character string which reproduces the trademark registered by the approved manufacturer. When the individual using the apparatus 1 has been informed beforehand that he has to type the trademark into the keyboard in order to validate his transaction, the apparatus 1 reproduces the trademark at the moment of the transaction. The register 21 is connectable to the card 9 so as to receive the original message therefrom.

A logic unit 22 is designed to generate a logical combination of “exclusive or” type of each bit of the register 20 with a bit of corresponding rank of the register 21. A register 23 is provided for containing the result of the logical combination generated by the logic unit 22. The logic unit 22 is for example a collection of one or more logic gates of “exclusive or” type each receiving as input a bit of the register 20 and a bit of the register 21 so as to output a bit of the register 23. According to another example, the logic unit 22 is a microprocessor programmed to perform a combination of bitwise “exclusive or” type of the content of the registers 20 and 21 and to place the result in the register 23. The logic unit 22 and the registers 20, 21, 23 thus makes it possible to execute step 12 of the method so that the register 23 contains the original message in coded form. The register 23 is connectable to the screen 8 so as to display the coded message thereon or connectable to an output port of the apparatus 1.

Another device comprising a register 25 and an adder 24 is designed to supplement the coded message contained in the register 23 with the approved manufacturer's identification number which is contained in the register 25. This other device makes it possible for example to concatenate the identification number with the coded message before transmitting it to the screen 8 or to an output port (not represented).

FIG. 4 shows a diagram of a server 26 hosted by the electronic equipment 3.

The server 26 comprises a register 27 designed to receive the coded message and a table 29 comprising one or more registers 31 each for containing the bits of a digital key whereof an apparatus manufacturer is the owner.

A logic unit 28 accessing the register 27 and the table 29 is provided in order to execute a program contained in a memory 30 so as to constitute a first device designed to decode message received in the register 27 by means of a digital key whereof a manufacturer of the apparatus is the owner in accordance with step 18 of the method previously described.

The memory 30 also contains a register 33 for containing a logical combination of exclusive or type of each bit of the register 31 with a bit of corresponding rank of the register 27. The logical combination is obtained by executing the program previously mentioned.

Advantageously, the table 29 is indexed by means of a register 32 associated with each register 31. Additional instructions contained in the memory 30 constitute, together with the logic unit 28, a second device designed to determine the digital key which is appropriate as a function of a manufacturer identification number received with the coded message in the register 27. In a manner which is simple for a programmer, the instructions are written so as to make the logic unit 28 point to the register 32 of the table 29 which contains an identification number of identical value to that received in the register 27 and to load the digital key of the register 31 with which the register 32 is associated so that this digital key is that used by the first device.

1. A method for authenticating that a message received by an addressee electronic equipment is a message coming from an apparatus authorized to certify said message, comprising the steps of:
generating a coded message by means of the apparatus which codes an original message, by means of a digital key whereof a manufacturer of the apparatus is the owner;
transmitting the coded message to the addressee electronic equipment;
decoding the coded message is decoded by means of said digital key.

2. The method as claimed in claim 1, wherein said digital key whereof the manufacturer is the owner, reproduces a registered trademark whereof the said owner manufacturer is the proprietor.

3. The method as claimed in claim 1 wherein:
the original message is coded by combining each bit of the digital key with a bit of corresponding rank of the original message, by means of a logical combination of exclusive or type;
the coded message is decoded by combining each bit of the digital key with a bit of the same corresponding rank of the coded message, by means of a logical combination of exclusive or type.

4. The method as claimed in claim 3, wherein the coded message is transmitted with a manufacturer identification number.

5. An apparatus for certifying a message intended to be transmitted to an addressee electronic equipment, comprising a first device designed to code an original message by means of a digital key whereof a manufacturer of the apparatus is the owner.

6. The apparatus for certifying a message as claimed in claim 5, wherein said device comprises a first register for containing each bit of said digital key, a second register for containing bits of the original message, each rank corresponding to the rank of a bit of the first register, a third register for containing a logical combination of exclusive or type of each bit of the first register with a bit of corresponding rank of the second register.

7. The apparatus for certifying a message as claimed in claim, comprising a second device designed to supplement the coded message with an owner manufacturer identification number of said digital key.

8. Electronic equipment for authenticating that a message received is a message coming from an apparatus authorized to certify said message, comprising a first device designed to decode said message received by means of a digital key whereof a manufacturer of the apparatus is the owner.

9. The electronic equipment as claimed in claim 8, wherein said first device comprises a first register for containing each bit of said digital key, a second register for containing bits of the coded message, each rank corresponding to the rank of a bit of the first register, a third register for containing a logical combination of exclusive or type of each bit of the first register with a bit of corresponding rank of the second register.

10. The electronic equipment as claimed in claim 8, comprising a second device designed to determine said digital key as a function of a manufacturer identification number received with the coded message.
